(19) United States
(12) Patent Application Publication
(10) Pub. No.: US 2004/0121646 A1
(43) Pub. Date: Jun. 24, 2004

(54) Modified, field installable, field adjustable flexible angled boot for multi-conductor cables and process for installing the same

(76) Inventors: Joseph Iamartino, Thompson, CT (US); Matthew J. Mannell, Hawthorn, NJ (US); Richard G. Nolan, Johnson City, NY (US); John M. Ehrenreich, Ellicott City, MD (US)

Correspondence Address: Robert J. McAughan, Jr., Howrey Simon Arnold & White, LLP, 750 Bering Drive, Houston, TX, 77057-2198, US

(21) Appl. No.: 10/431,212

(22) Filed: May 7, 2003

Related U.S. Application Data
(63) Continuation-in-part of application No. 10/323,300, filed on Dec. 18, 2002.

(51) Int. Cl. H01R 13/56

(52) U.S. Cl. 439/445

(57) ABSTRACT

The present disclosure relates to connector assemblies for use with multi-conductor connection cables. More specifically, the present disclosure relates to a flexible angle configurable boot assembly for use with a multi-conductor cable where the angle configurable boot defines an area for receiving the multi-conductor cable for positioning the cable at a known angle and/or orientation with respect to the flexible angle configurable boot in at least one location, and where the angle configurable boot may be coupled to the cable connector in one or a plurality of alternate orientations. The present disclosure also relates to a process for installing such a flexible angle configurable boot assembly.

### CROSS REFERENCE TO RELATED APPLICATIONS

The present application is a Continuation-In-Part of pending U.S. patent application Ser. No. 10/323,300 filed Dec. 18, 2002. The contents of the foregoing application are incorporated herein by reference.

### FIELD OF THE DISCLOSURE

The present disclosure relates to connector assemblies for use with multi-conductor connection cables. More specifically, the present disclosure relates to a flexible angle configurable boot assembly for use with a multi-conductor cable where the angle configurable boot defines an area for receiving the multi-conductor cable for positioning the cable at a known orientation or angle with respect to the angled boot in at least one location, and where the angled boot may be coupled to the connector in one or a plurality of alternate orientations. The present disclosure also relates to a process for installing such a flexible angle configurable boot assembly.

### BACKGROUND OF THE DISCLOSURE

Modern information systems such as telecommunication systems, computing systems and the like typically rely upon one or more connection cables to couple the various components of the system together for purposes of communication. The connection cables typically include one or more conductive elements (such as, for example, wires and/or optical fibers) that are used to communicate information through the connection cable in the form of electrical and/or optical signals.

To promote high bandwidth communications and to reduce the number of connection cables needed for a system, many connection cables include a plurality of conductive elements and may include, for example, several wires or optical fibers within a single connection cable. Such multi-conductor connection cables may include, for example and without limitation, four, eight or twelve optical fibers or wires. The multiple conductors in a multi-conductor connection cable may be arranged in various ways including a side-by-side relationship or an arrangement where the conductors form a generally cylindrical cable. In many multi-conductor connection cables that include a number of optical fibers, the optical fibers comprising the connection cable are arranged in a side-by-side relationship to form a cable commonly known as a “ribbon cable.”

FIG. 1 generally illustrates the components that form a traditional twelve optical fiber ribbon cable 10. For purposes of illustration, the ribbon cable 10 of FIG. 1 is illustrated as being a “jacketed” cable, meaning that it includes an outer protective jacket although many ribbon cables are “unjacketed” and do not include the protective jacket.

Referring to FIG. 1, the exemplary illustrated ribbon cable 10 includes twelve optical fibers 12, although it will be appreciated that a ribbon cable can have anywhere from two optical fibers to a number substantially greater than twelve (e.g., seventy-two). To prevent light traveling down one of the optical fibers from creating interference or noise with adjacent optical fibers, and to protect each fiber, each of the optical fibers is surrounded by a buffer material 14 that may be in the form of a plastic jacket or the like. While the thickness of the buffer material 14 will vary from application to application, it is not uncommon for the buffer material to have a thickness of at least 250 micrometers. To hold the fibers forming the ribbon cable 10 together and to provide strength and stretch resistance, an outer binding material 16 typically surrounds the individually buffered cables. In the example of FIG. 1, the outer binding material takes the form of an outer layer of Aramid yam. A protective jacket 18, which may be formed of a rubber or flexible plastic material, surrounds the binding material 16.

In an effort to ensure that the appropriate communications links are established when a connection cable is coupled to a system component, most connection cables include at least one connector element positioned at an end of the connection cable. The connector typically includes a housing structure that receives an end of the connection cable. The connector is typically formed so as to be received in a mating engagement fashion with a terminal positioned on the system component to which the connection cable is to be attached. The conductive elements that form the connection cable (e.g., the wires or optical fibers) are either coupled to further connection elements, such as for example, an optical ferrule assembly or an electrical terminal pin or exposed in such a way that when the connector is coupled to the terminal on the system component, the appropriate conductive elements on the cable are coupled to appropriate corresponding elements with the system components such that information in the form of, for example, electrical or optical signals may be transmitted through the connection cable to the system component.

For multi-conductor fiber optical connection cables, especially multi-optical fiber connector cables utilizing ribbon cables as described in connection with FIG. 1, connectors that include a housing defining a generally rectangular opening that provided access to an optical ferrule within which the optical fibers forming the cable are embedded. One such connector that is commonly used in connection with such ribbon cables in the connector style known in the art as the MPO (multipath push on) connector, a form of which is known as the MTP© connector. The MPO connector is a multi-fiber connector that can be used with connection cables having 4, 8, 10, 12 or higher fiber counts.

FIG. 2 generally illustrates a connection cable 20 that includes a multi-conductor ribbon cable 22 having the construction, for example, of the twelve-fiber cable of FIG. 1. An MPO connector 24 is coupled to a terminal end of the ribbon cable 22 such that the individually optical fibers that form the cable 22 are accessible through the housing to allow for a ready connection between one element of a system and another element of the system through the connector 24 and the connection cable.

One difficulty with many multi-fiber connection cables and connector systems is that because of the many elements that form the multi-fiber cable, the cable portion of the connection cable is very stiff and difficult to bend in confined or tight areas. For example, it may require significant force to bend the twelve-fiber cable of FIG. 1 (including the fibers, the buffer material, the binding material and the jacket), and once bent, the cable will have a tendency to re-straighten itself. This difficulty in bending and tendency to straighten can cause significant difficulties in applications where a large number of connection cables are to be coupled to a system component or number of system components. In such applications, the stiffness of the ribbon cable can render system installations difficult, time consuming and confusing, and the tendency of the cables to straighten out after installation can, among other things, render the system unsightly and difficult to readily troubleshot and repair.

In addition to the problems described above, the construction of conventional multi-conductor connection cables often subjects the cables to undue stresses which could, in certain extreme instances, result in cable failure. For example, a ribbon cable such as that illustrated in FIGS. 1 and 2, because of its flat geometry, exhibits various stiffness characteristics at various points along the cable. Depending on the precise way in which the connector portion of the connection cable is coupled to the relevant system component, the cable may be forced to bend at an extreme angle or twist and bend. Such extreme bending and/or twisting and bending can expose the conductive elements (e.g., the optical fibers) to breakage as the bends and twists are often uncontrollable and difficult to manage. For example, referring to the cable of FIG. 2, a twist and/or extreme bend in cable 22 may result in breakage of one or more of the optical fibers forming the cable and, therefore, cable failure.

A further limitation of conventional multi-element cable systems is that the multi-conductor cable is often exposed to orientations which render the cable susceptible to failure. For example, in many applications, the orientation at which the connector of a cable is coupled to a system component will require a cable, for example a ribbon cable, to twist from one orientation to another orientation. Because the elements (e.g., optical fibers or wires) within the cable over the twisting portion of the cable will already be subject to some stress from the twisting forces, the application of additional forces to that portion of the cable (e.g., an uncontrolled bending force) may result in failure of the conductive element. For example, undue stresses can cause a fiber optical cable to break—rendering the fiber incapable of transmitting data in the form of an optical signal—or can cause a wire to bend or kink in such a way that a discontinuity in the wire is established that will cause interference or reflections of the transmitted electrical signals causing the wire to fail as a proper conductor of information. The problem with improper bends and kinks in wire-based cables is of particular significance where the cable is intended to support very high bandwidth communications.

Conventional approaches to solve the problems described above have fallen short. In certain applications, factory installed right angle boots have been permanently affixed to cable systems during manufacture. While providing support to protect the conductive elements within the cable, the permanently affixed boot is limited in that it establishes a fixed orientation of the cable with respect to the portion of the connection cable within the boot. As such, depending on the orientation of the connector to the system to which the connector is to be attached, the cable may be required to twist. Because the permanently attached angled boot prohibits twisting within the boot, any twisting of the cable will occur outside the confines of the permanently attached boot, thus exposing the cable to damage or breakage. A further limitation of conventional cables with permanently attached boots is that the permanently attached boot provides for only a single orientation of the cable with respect to the connector and that preselected and fixed orientation may not be the most convenient orientation.

To avoid some of the limitations of conventional permanently installed boots, some have used “boot clips” to control the bend radius of round, non-ribbon cables. The boot clip is typically a clip that attaches to the connector and to a round cable so as to control the bend of the cable. Unlike the permanently installed boots, boot clips can be installed in the field. Boot clips are limited, however, in that they do not prevent or control twisting of the cable to which the boot clip is attached. Moreover, boot clips typically are not readily adapted for use with ribbon cables.

The connector assembly and method of assembling the same described herein overcomes the above-described and other problems and limitations of conventional connectors.

### SUMMARY OF THE DISCLOSURE

In accordance with one exemplary embodiment of the present disclosure, a flexible angle configurable boot assembly for use with a multi-conductor cable that includes a connector is provided wherein the flexible angle configurable boot assembly includes a flexible angled boot that is capable of receiving the multi-conductor cable and is configurable for locking into any angle between 0° and 90°, a structure for positioning the cable at a known orientation with respect to the angled boot in at least one location, and a structure for coupling the angled boot to the connector in one or a plurality of alternate orientations.

In accordance with a further exemplary embodiment of the present disclosure, a process for installing a flexible angle configurable boot assembly on a connection cable that includes a multi-conductor cable and a connector is provided, wherein the process includes the steps of coupling a clip defining an outer mounting structure to the connection cable at a location where the multi-conductor cable is received by the connector, positioning the multi-conductor cable within the flexible angle configurable boot so as to define the orientation of the multi-element cable with respect the flexible angle configurable boot, positioning the flexible angle configurable boot so as to define the angle of strain relief and locking the boot into the angle, and coupling the flexible angle configurable boot to the outer mounting structure at a desired orientation.

### DESCRIPTION OF THE FIGURES

The following figures form part of the present specification and are included to further demonstrate certain aspects of the present disclosure. The disclosure may be better understood by reference to one or more of these figures in combination with the detailed description of specific embodiments presented herein.

FIG. 1 generally illustrates the components that form a traditional twelve optical fiber ribbon cable 10.

FIG. 2 generally illustrates a connection cable 20 that includes a multi-conductor ribbon cable 22 and an MPO connector 24.

FIG. 3A generally illustrates an exemplary embodiment of an improved field installable, field adjustable angled boot for multi-conductor cables and a process for installing the same. Specifically, the process of installing the cable clips is shown.

FIG. 3B generally illustrates the process of connecting the cable clips to the cable connector.

FIG. 3C generally illustrates the attachment of the angled boot attachment to a cable.

FIG. 3D generally illustrates the engagement of the angled boot with the outer portion of the clips to form a connector assembly.

FIG. 4A generally illustrates an exemplary embodiment of the angled boot and cable clip of the disclosure.

FIG. 4B illustrates an orientation of the angle boot of 0° with respect to the cable clips.

FIG. 4C illustrates an orientation of the angle boot of 45° with respect to the cable clips.

FIG. 4D illustrates an orientation of the angle boot of 90° with respect to the cable clips.

FIG. 5A illustrates a protective embodiment of the angled boot, wherein no twisting of the cable is required.

FIG. 5B illustrates a protective embodiment of the angled boot, wherein twisting of the cable in order to align the cable with a system component is required.

FIG. 6A generally illustrates an alternative embodiment construed in accordance with certain teachings of the present disclosure, wherein the cable clip is permanently molded into the cable connector.

FIG. 6B generally illustrates the attachment of the angled boot attachment having permanently molded cable clips to a cable.

FIG. 7 illustrates a typical prior art duplexing optical fiber connector.

FIG. 8A illustrates an alternative embodiment constructed in accordance with certain teachings of the present disclosure involving a double angled boot and a duplexing clip.

FIG. 8B illustrates a protective embodiment of an alternative embodiment constructed in accordance with certain teachings of the present disclosure, wherein a double angled boot protects a cable which must be twisted in order to align the cable with a system component.

FIG. 9 illustrates an alternate embodiment constructed in accordance with certain teachings of the present disclosure, where a flexible, locking hinged boot protects the cable and controls the radius of the bend.

FIG. 10 illustrates the flexible, locking cable boot of FIG. 8 in it's 0° orientation and it's 90° bend orientation.

FIG. 11 illustrates a 3-dimensional view of the flexible locking cable boot of FIG. 9.

### DETAILED DESCRIPTION OF THE DISCLOSURE

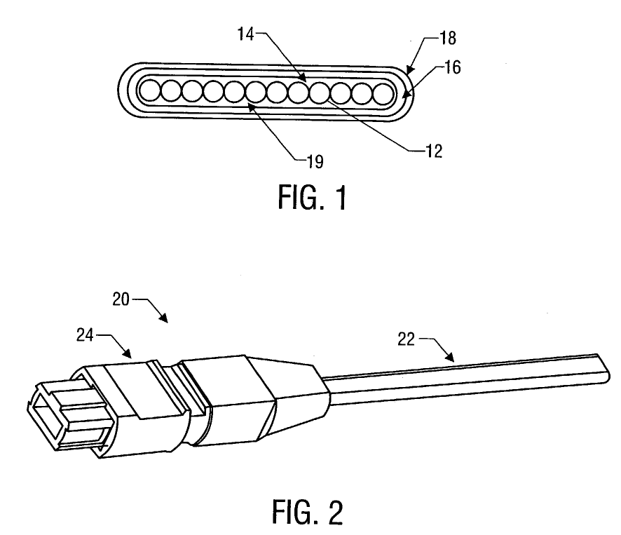

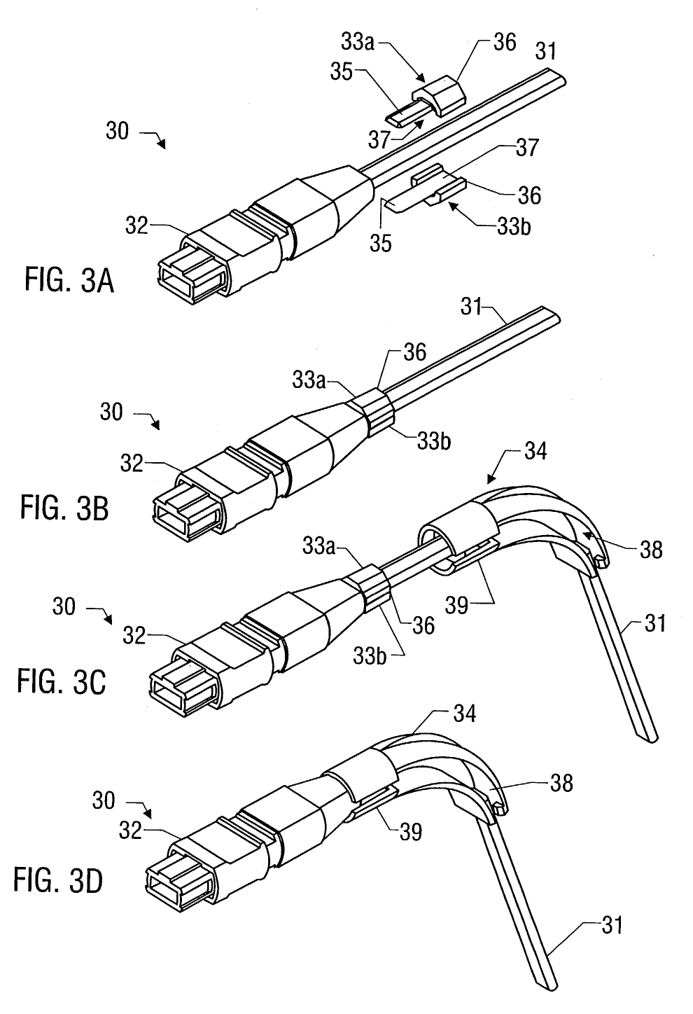

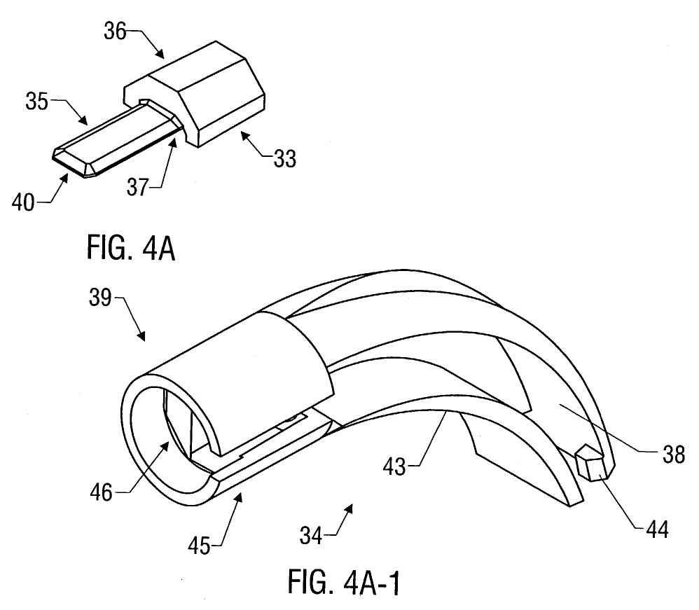

Referring to the drawings, in particular to FIGS. 3A-3D, a connection cable assembly 30 is illustrated for use in applications where a connection cable is to be bent at or after initial installation. In general, the cable assembly 30 includes a multi-conductor cable component 31 that may be, for example, a multi-optical fiber ribbon cable as described above in connection with FIG. 1. The cable assembly further includes a connector 32 that, in the illustrated exemplary embodiment, is an MPO-type connector having a rectangular opening as described above in connection with FIG. 2. Coupled to the connector 32 are cable clips 33a and 33b and coupled to the cable clips 33a-33b is an angled boot 34. The outer exterior surface of the cable clips 33a and 33b is received in the interior of the angled boot 34 such that the angled boot 34 maintains a controlled and protective bend of the ribbon cable 31 as it exits the connector 32. The angle of the bend defined by the angled boot 34 is such that no undue stresses are placed on the cable 31.

By providing a controlled bend in the cable 31, the connection assembly of FIGS. 3A-3D maintains and controls the bend radius of the cable (ensuring an appropriate minimum bend radius). It also inhibits undesirable, unprotected twists and bends of the cable 31. Moreover, because the bend of the cable 31 is controlled, the connection assembly 30 directs the cable 31 in a defined and known manner and helps maintain and promote neat cable management enabling faster, less costly system installation and simplifying system maintenance and repair.

FIGS. 3A-3D further illustrate an exemplary method by which the assembly 30 may be assembled. Focusing first on FIG. 3A, a conventional connection cable having a ribbon cable 31 and a connector, such as an MPO connector 32, is illustrated. This is the type of cable that may be obtained as an “off the shelf” item. As illustrated in FIG. 3A, the cable clips 33a and 33b include a thin portion 35 and an outer housing portion 36. The clips also include an interior recess 37 sized to receive the cable 31.

The thin portions of the cable clips 33a and 33b are sized to be able to slip into the space defined by connector 32 where the cable 31 mates with the connector 32 so as to couple the clips 33a and 33b to the connector 32 through a slip-fit connection. To connect the clips 33a and 33b to the connector, one—either in manufacturing or in the field during system installation or maintenance—slips the thin portions 35 of the cable clips under and between the existing MPO connector 32 and the cable 31 to produce the cable 30/connector clip assembly of FIG. 3B.

Referring to FIG. 3C, the angled boot 34 may then be placed about the ribbon cable 31. In the illustrated example of FIG. 3C, the angled boot 34 defines a generally rectangular slot 38 into which the ribbon cable 31 is received. The angled boot 34 further defines a proximal outer housing portion 39 that is sized to mate with the outer housing portion 36 of clips 33a and 33b. During installation, after the clips 33a and 33b are coupled to the cable 31 and the connector 32, the cable 31 is positioned within the angled boot 34, and the angled boot 34 is slid until the outer housing 39 of the angled boot 34 engages with the outer housing 36 of the clips 33a and 33b to form the connector assembly 30 of FIG. 3D.

Because the precise orientation of the connector 32 and the orientation of the desired bend of a cable 31 with respect to the connector 32 may not be known, it is desirable that the connector assembly be able to allow the angled boot 34 to extend from varying orientations from the connector 32. In one exemplary embodiment, the outer housing 36 of the cable clips 33a and 33b and the outer housing 39 of the angled boot 34 are formed such that the angled boot 34 an be coupled to the clips 33a-33b and, thus, to the connector 32 in a variety of orientations. This embodiment allows for “field selection” of the angle of the boot 34 to the connector 32.

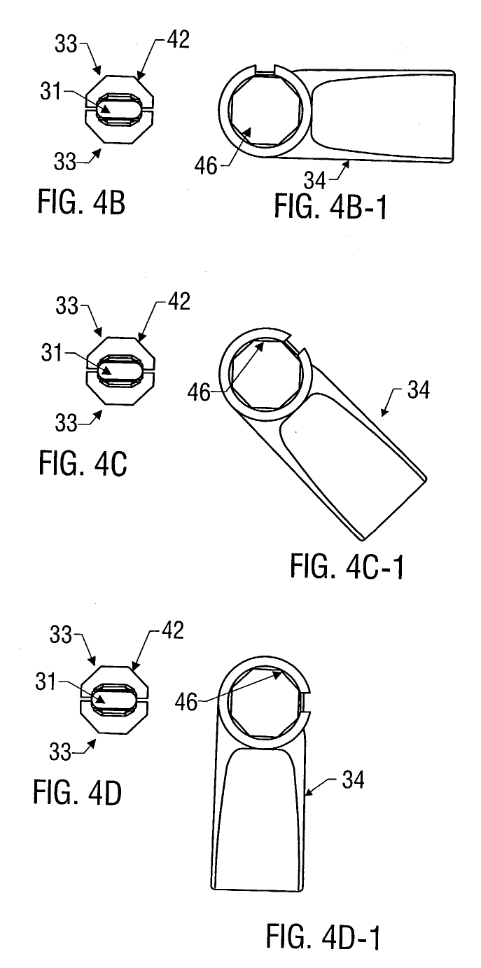

FIGS. 4A-4D generally illustrate an embodiment of the connector assembly 30 of FIG. 3A that provides for field selectable orientation of the angled boot 34 with respect to the connector 32.

Referring to FIG. 4A, details of an exemplary cable clip 33 and an angled boot 34 are provided. Only one cable clip 33 is illustrated as the other clip 33 will have the same construction.

Referring to FIG. 4A, the cable clip includes the thin portion 35 and an outer housing 36, as described above. The thin portion 35 is provided with sloped edges to enable easier insertion into the space between the cable 31 and the connector 32.

In the example of FIG. 4A, the outer surface of the outer housing 36 defines the interior recess 37 that is sized to receive the ribbon cable 31, and the outer surface 36 defines a “half-octagon.” The cable clip 33 is configured such that when the two cable clips 33 are coupled to the connector 32 as illustrated in FIGS. 4B-4D, the interior recesses 40 of the cable clips 33 surround the ribbon cable 31 and the outer surfaces 36 of the outer housings of the clips form an outer octagonal surface 42. This is generally illustrated in FIGS. 4B-4D which illustrates a view of connector clips 33 surrounding a ribbon cable 31. Note: In FIGS. 4B-4D, the connector 32 to which the cable clips 33 would be connected is not illustrated.

Referring to FIGS. 4A-4D, the angled boot 34 includes a bent portion 43 that, in the illustrated embodiment, defines a generally rectangular slot 38 that is sized to receive the ribbon cable 31. The degree of the bend of the angled boot 34 should be selected so as to ensure that no undue bending forces or stresses are placed on the cable 31. Because the ability of a cable to handle bending stresses will vary from cable to cable, the precise degree of the bend of the angled boot 34 may vary from application to application. In general, however, the bend of the angled boot 34 should be such that the radius of the bend of the boot is greater than or equal to ten times the dimension of the shortest cross-section of the cable 31. Thus, for a ribbon cable that has a major axis (the width of the ribbon) and a minor axis (the height of the ribbon), the radius of curvature of the angled boot 34 should be at least ten times the minor axis. Embodiments of multiple versions of the angled boot 34 are provided having differing degrees of bend to accommodate different applications.

The dimensions of the slot 37 should be such that the ribbon cable can “twist” within the slot 37 if the orientation of the connector and the cable are such that a twisting of the cable is desired. Accordingly, the slot should be sized such that both of the dimensions of the slot (i.e., the width and height of the slot 37) are greater than the largest cross-section of the cable 31.

One or more capture elements 44 are provided near the distal end of the bent portion of the angled boot 34 to capture the cable 31 within the slot 38. This capturing of the cable within the slot ensures that the orientation of the cable 31 within the slot 38 at the distal end of the boot 34 is known and defined. In the illustrated example, the capture element 44 consists of a raised nib that may be biased away from the slot by pressure to insert the cable 31 into the slot and that, when released, presses against the cable 31 to retain the cable with the slot in a defined orientation. In the illustrated example, the capture element 42 and the slot 38 are configured such that when the cable 31 is positioned within the slot, the orientation of the cable 31 at the point where the capture element 44 engages the cable 31 will be such that the flat side of the cable will be resting on the lower flat portion of the slot 38. Other known orientations are possible.

The presence of the capture element 44 ensures that any twisting of the cable 31 necessary to accommodate a particular orientation of the cable with respect to the connector 32 will occur within the protective confines of the angled boot 34. As such, the portion of the cable 31 that would be most vulnerable to uncontrolled bending forces (i.e., the portions over which the twist is occurring) are protected from potentially damaging forces by the substantially rigid angled boot 34.

In the illustrated example, the outer housing 39 of the angled boot 34 defines a sleeve member 45 that defines—throughout at least part of its interior surface—an inner octagon surface 46 that is sized to fit in a press fit relationship about the outer octagon surface 42 defined by the outer surface of the cable clips 33. Because the inner octagon surface 46 defined by the angle boot 34 is sized to mate with the outer octagon surface 42 of the cable clips 33, in the illustrated example, the angled boot 34 may be coupled to the cable clips 33—and thus the connector 32—in one of eight possible orientations. Each orientation is offset from an adjacent orientation by 45°. Examples of the various orientations of the angled boot 34 with respect to the clips 33—and thus with respect to the connector 32—are illustrated in FIGS. 4B-4D.

In the illustrated example, all of the components of the connection assembly including the cable clips 33 and the angled boot 34 are formed of molded plastic using known molding techniques and processes.

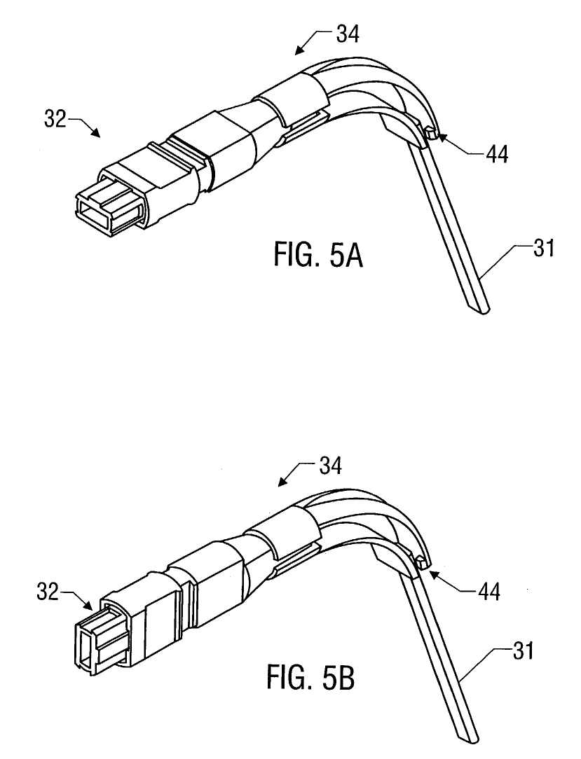

FIGS. 5A-5B illustrate protective advantage provided by the angled boot 34 described above in applications where a twisting of the cable must occur. Referring to FIG. 5A, an arrangement is illustrated where the orientation of the connector 32, when coupled to a system component (not illustrated), is such that no twisting of the cable 31 is required. Specifically, in the example of FIG. 5A, the flat portion of the rectangular opening of the connector 32 (through which connection is made with the cable) is aligned with the flat portion of the cable 31. As such, in this example, the angled boot 34 controls the degree of the bend of the cable 31, but the cable 31 does not “twist” within the angled boot 34.

FIG. 5B illustrates an arrangement similar to that described above in connection with FIG. 5A. In the arrangement of FIG. 5B, however, when the connector 32 is coupled to a system component (not illustrated) the rectangular opening through which connection with the conductive elements of the cable 31 is made is not in alignment with the flat portion of he majority of cable 31. Accordingly, in this illustrated example, the cable 31 must “twist” at some point near the connector 32. In the illustrated example, the capture element 44 holds the cable 31 in a known position at the end portion of the angled boot 34 such that the flat portion of the cable as it exits the angled boot 34 is aligned with the flat portion of the majority of the length of the cable. Accordingly, the capture element 44 defined by the angled boot 34 ensures that the twisting of the cable 31 occurs within the protection of the angled boot 34.

While the apparatus and methods of this disclosure have been described in terms of preferred embodiments, it will be apparent to those of skill in the art that variations may be applied to the apparati described herein without departing from the concept and scope of the disclosure. For example, the apparatus and methods described herein are not limited to use with the MPO connectors used in the exemplary embodiments. The apparatus and process of the present disclosure is also applicable to other forms of MPO connectors and other forms of connectors.

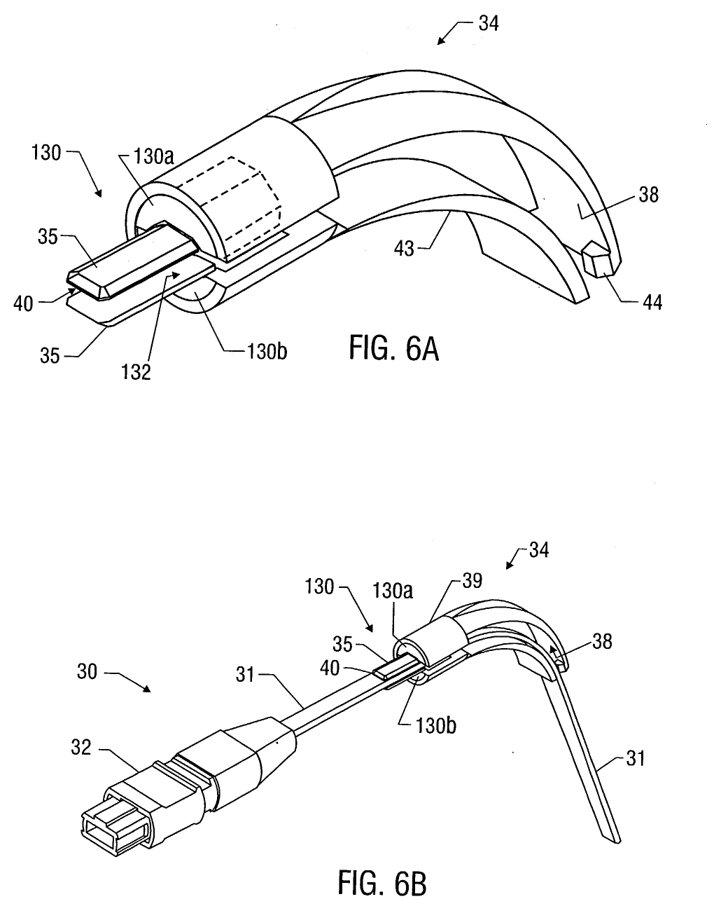

An example of such a variation applicable to the apparatus and methods of this disclosure is illustrated in FIGS. 6A-6B. Referring to the drawings, a connection cable assembly having the cable clip permanently mounted into the angled boot 34 is shown. As with previous embodiments, this connection assembly provides for field selectable orientation of the angled boot 34 with respect to a connector. N.b., in FIG. 6A, the connector 32 to which the cable clip 130 would be connected, as well as the ribbon cable 31, are not illustrated for means of clarity.

Referring to FIG. 6A, details of an exemplary permanently mounted cable clip 130 and an angled boot 34 are provided. As with the removable cable clips 33 described before, permanently mounted cable clip assembly 130 has mounted housings, 130a and 130b and a thin portion 35. Mounted housing 130a is the upper half of the permanent clip, and mounted housing 130b is the lower half of the permanent clip, similar to what has been described previously herein. The thin portion 35 extends away from and parallel to outer housing 39, and is provided with sloped edges to enable easier insertion into the space between a cable and the connector.

In the example shown, the mounted upper and lower housings 130a and 130b and thin portions 35 parallel to the housings define interior recesses 132 and 40, respectively. These interior recesses are, as described for FIGS. 4A-D above, sized to receive the ribbon cable 31. Permanently attached connector clip assembly 130 can be attached to housing 39 by means of molding, or by means of a permanent adhesive. In the case of molding, connector clip assembly 130 can be permanently molded as part of the entire angled boot 43 during the manufacturing process. In the event that the permanently attached connector clip assembly 130 is attached by means of a permanent adhesive, any suitable adhesive known to those of skill in the art is within the scope of the present disclosure.

The angled boot portion 43, as shown in this embodiment, defines a generally rectangular slot 38 that is sized to receive a ribbon cable 31. The degree of bend of the angled boot can, as described earlier, be selected so as to ensure that no undue bending forces or stresses are placed on the cable. Capture element 44, such as the raised element shown, can be biased away from the slot 38 by pressure in order to insert cable 31 into the slot and then, upon release, presses against the cable to retain it within slot 38 in a defined orientation.

Referring to FIG. 6B, an exemplary method by which the assembly of FIG. 6A is illustrated. Angled boot 34 having permanently attached connector clip assembly 130 can be placed about the ribbon cable 31. In the illustrated example, the angled boot 34 defines a generally rectangular slot 38 into which the cable 31 is received. The angled boot 34 further defines interior recess 40 within the outer housing portion by means of the permanently attached connector clip assembly 130, and cable 31 is readily received into this recess. At this point, and as illustrated in the Figure, the ribbon cable 31 is extending out from a connection assembly 30, between the upper and lower housings 130a and 130b of clip assembly 130, and through the angled boot 34. The thin portions 35 of the permanently attached connector clips are then inserted under and between the existing MPO connector 32 and the cable 31 to produce the angled boot assembly shown in FIG. 3D previously.

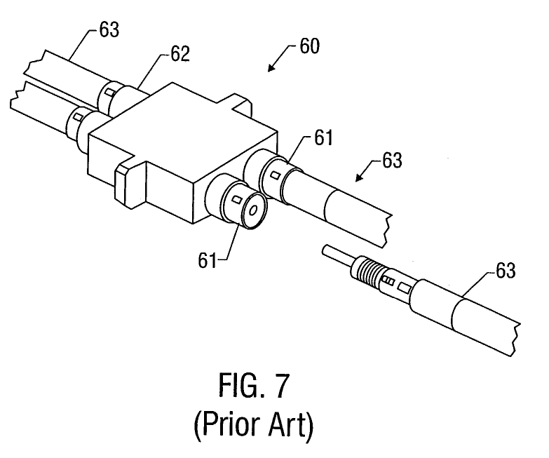

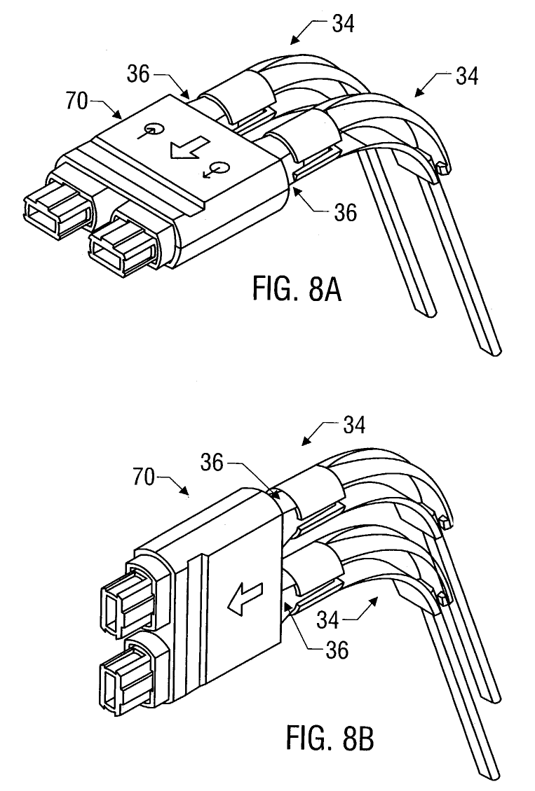

FIGS. 8A and 8B illustrate an alternate embodiment of the apparatus and process in accordance with certain teachings of the present disclosure wherein angled boots 34 of the present disclosure are used with a “double” MPO connector 60. In such an embodiment, clips 36 serve as duplexing clips, which can be color-coded or labeled in any manner known in the art in order to differentiate the cables. As illustrated in FIG. 7, the prior art approach to duplexing typically involves connectors of the type shown. As depicted in this general representation, a duplexing adapter housing 60 comprises two pairs of mating members 61 and 62, so that the two mating members 61 are arranged on one side of the duplexing adapter housing 60. In this way, the basic plugs 63 can-be fixed into the mating members 61 from both ends. This same arrangement can be made with only one pair of mating members 61 arranged on the same side/face of the duplexing adapter. No allotment is made for providing a controlled bend in the cables or preventing undesirable, unprotected twists and bends of the cables.

The alternate embodiment illustrated in FIGS. 8A and 8B allows the cables to be in varying rotational arrangements with regard to each other. This can be useful, for example, wherein one cable is a transmitting cable and one cable is a receiving cable. As illustrated in the horizontal arrangement of FIG. 8A, the angled boots 34 allow two cables to be arranged at angles away from the connector 70 and remain on both the same side and in the same plane with relation to the connector. In the vertical arrangement of FIG. 8B, the angled boots 34 allow for the cables to pass over one another (e.g. the top cable passes over the bottom cable) in a vertical mounting configuration. Angled boots 34 allow the cables to be positioned appropriately so that the flat portion of the cable exits the angled boot 34 in such a way that it is aligned with the flat portion of the majority of the length of the cable, and is substantially parallel with the cable exiting from the second angled boot. As with other embodiments described herein, the angled boots 34 ensure that any twisting of the cable that does occur in such a duplexing arrangement occurs within the protection of the angled boot. The apparatus and process of the present disclosure may be applied to many other types of connectors including, for example and without limitation, MMC (multi-media card) and SMT (sub-miniature C) style connectors and LC type connectors.

As a further example, the use of the cable clips, such as clips 33a and 33b, are not necessarily required to provide a base for attachment of the angled boot to the connector housing. Any mechanism capable of providing a secure adjustable attachment of the angled boot to a connector will be within the scope of the present disclosure. Alternate embodiments are envisioned wherein an outer mating surface—like the octagonal surface 42 of clips 33—is integrally formed with and defined by a connector 32. Further alternate embodiments are envisioned wherein surfaces other than octagonal surfaces such as triangular, square, hexagonal, decahedral, dodecahedral, and icosahedral surfaces—are utilized to provide an adjustable mating between the angled boot and the connector or an element attached to the connector. Still further alternate embodiments are envisioned wherein the angled boot snaps around or under the connector housing or wherein a screw-type connection is provided to allow the angled boot to be coupled to the housing in a variety of orientations.

Further embodiments are envisioned wherein some sort of locking structure, such as a cotter pin passing through mating elements or a C-clip is provided to lock the angled boot in place once it is positioned at the desired orientation.

As yet a further example of variations that would be within the scope of this disclosure, the angled boot 34 need not have the precise construction illustrated herein. Alternate designs that do not utilize a slot, such as slot 38, are envisioned. In such embodiments, the angled boot 34 may have a two-piece construction and may be such that it can be snapped around a multi-conductor cable. Still further alternate embodiments are envisioned where the capture element of the angled boot is something other than a raised nib, such as some form of a gripping device.

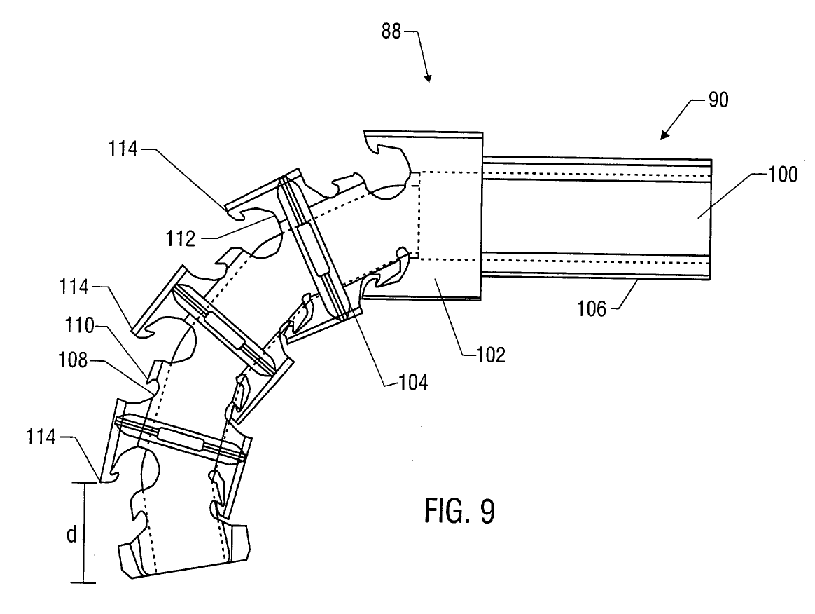

Variations within the scope of the present disclosure, wherein the angled boot 34 does not have the precise construction described previously, are shown in FIGS. 9-11. As shown therein, the angled boot can be a right angle configurable flexible boot 90 that is a multi-part design. The interior section 100 of the angle configurable boot 90 is a smooth, flexible tube that the cable fits through. The exterior section 88 allows for a variety of angular rotations of the cable, which is protected by the interior section, allowing the cable to be turned from a straight angle to a 90° angle and then locked into position.

FIG. 9 illustrates a flexible, locking variation of the angled boot design 90 of the present disclosure. The angled boot comprises two parts, an inner protective chamber 100 that is flexible, and a more rigid, linked outer casing 88 that is capable of bending and locking in any number of angles between 0° and 90°. Outer casing 88 consists of a plurality of locking body elements 102 extending from the proximal end 106 to the distal end opposite the proximal end 106. The plurality of locking body elements 102 are capable of being pivoted with respect to each adjacent element on a vertical axis. As shown in the figure, the outer casing locking body elements 102 are made up of a series of latches 114, hooks 110, and pivot points 104, as well as angle-defining spaces 112 and locking spaces 108. Latches 114 can consist of a beveled nib that is biased toward the hooks 110 so that, when brought under hook 110 and pressed against the bottom side of hook 110 at the forward end and against the locking space 108, the boot is locked in the desired angle. Each of the locking body elements 102 can be the same, or they can vary in size (such as diameter) as appropriate. FIGS. 9, 10 and 11 illustrate a preferred embodiment of suitable elements, wherein throughout a substantial part of the length, the elements are the same size. However, it is envisioned that from a point, such as the middle of the length of the boot 90, the locking body elements 102 can become progressively smaller, as necessary.

Although not shown within the Figures, proximal end 106 of the flexible angle configurable boot 90 could be further defined by a proximal outer housing portion that is sized to mate with the outer housing portion 36 of cable clips 33a and 33b shown in FIG. 3A. Such a proximal outer housing portion could be either formed as a part of the flexible angle configurable boot 90 itself, or it could be a separate component that can be simply slid over the extended interior section 100 at the proximal end. The interior section 100 defines an area for receiving the multi-conductor cable. Similarly, the proximal outer housing portion, whether included as a section of boot 90 or as a separate component, can have cable clips 33a and 33b permanently attached. Such a permanent attachment can be by an appropriate adhesive, or the cable clips can be molded into the proximal outer housing itself.

In the illustrated example of FIG. 9, in forming the flexible angle configurable boot to the desired angle, the outer casing 88 is twisted to the approximate angle by pivot points 104. Appropriate latch 114 is then brought over hook 110 such that hook 110 is within the space defined by angle-defining space 112. Latch 114 is then pushed under the lip of hook 110 and into the space defined by locking space 108, thereby locking the boot into the desired angle.

The flexible angle configurable boot 90 can also optionally include a generally rectangular slot sized to receive a cable, such as ribbon cable 31. The degree of bend of the flexible angle configurable boot 90 should preferably be selected so as to ensure that no undue forces or stresses are placed on the cable. Because the ability of a cable to handle bending stresses will vary from cable to cable, the precise degree of angled bend of the flexible angle configurable boot 90 can vary from application to application. In general, however, the angle of bend of the flexible angle configurable boot 90 should be such that the radius of bend of the boot is greater to or equal to ten times the dimension of the shortest cross-section of the cable. Suitable angles are any angle between 0° and 90°, depending upon the cable and the length of the flexible angle configurable boot 90.

Additionally, one or more capture elements, such as a raised nib or the like, can be provided at or near the distal end of the flexible angle configurable boot to capture the cable within the optional slot. This capturing of the cable within the slot can ensure both the orientation of the cable within the slot itself, within the inner chamber 100, as well as the retention of the cable within the slot as the boot 90 is bent and or twisted during use. Any of a variety of positions and orientations of the capture element(s) are possible, and would vary depending upon application.

An exemplary method by which the flexible angle configurable boot assembly can be assembled is described generally, and is similar to those methods illustrated in FIGS. 3A-3D. As illustrated therein, a conventional connection cable having a ribbon cable and a connector, such as an MPO connector, is obtained. Cable clips, such as cable clips 33a and 33b in FIG. 3A can be inserted into the space defined by the connector where the cable meets with the connector so as to couple the clips to the connector through a slip-fit connection.

The flexible angle configurable boot 90 can then be placed about the ribbon cable. This can be accomplished either by sliding the cable through the inner chamber 100 of boot 90 such that the connector is near the proximal end 106 and the tail of the cable protrudes out from the distal end of boot 90. Alternatively, the flexible angle configurable boot 90 can have a generally rectangular slot along one side of the boot, as described above. In such an instance, the cable can be positioned within the flexible angle configurable boot 90, and boot 90 can be slid forward until the proximal outer housing portion at the proximal end 106 engages with the outer housing of the clips 33a and 33b to form the connector assembly at the desired orientation.

The flexible angle configurable boot 90 can then be bent to the desired angle and locked into position in a manner as described above. For example, in forming a 90° bend, the boot 90 can be flexed to approximately 100°, whereupon locking elements 114 and hooks 110 would be allowed to lock into the appropriate defining spaces 108 and 112 and form the proper 90° angle.

As an alternative embodiment, the clips 33a and 33b described in the example above can be permanently mounted to the proximal end 106 of the flexible angle configurable boot 90 in a manner similar to that illustrated in FIGS. 6A-6B.

As with the angled boot assembly described previously, all of the components of the flexible angle configurable boot assembly 90, including the cable clips and the body elements 102, are preferably made of polypropylene, polyethylene, or any other suitable, hard plastic with the necessary strength and flexibility. The flexible angle configurable boot 90 can be formed of molded plastic, polypropylene, polyethylene, and the like as one piece, or as a series of pieces which are assembled, using known molding techniques and processes. Additionally, the flexible angle configurable boot 90 can be made of two pieces, such as a top and bottom piece, which snap together around the cable.

The range of angles which can be achieved using the flexible angle configurable boot 90 can be controlled by lengthening the boot to a distance that will allow for the specific desired angle, by changing the number of latches, or a combination of both. For example, the flexible angle configurable boot 90 of the present disclosure is capable of being bent and locked into an angle of 0°, 45°, 90°, or 120°. More specifically, the flexible angle configurable boot 90 of the present disclosure can be bent and locked at an angle between about 0° and about 180°, and more preferably can be bent and locked at an angle between about 0° and about 90°.

As is further illustrated, outer casing 88 has a proximal end 102 which joins and surrounds the outer casing to the inner chamber 100, and terminates in outer housing 106. Outer housing 106 can then have cable clips 33 inserted into the end, or can be designed with permanent cable clips such as those described above.

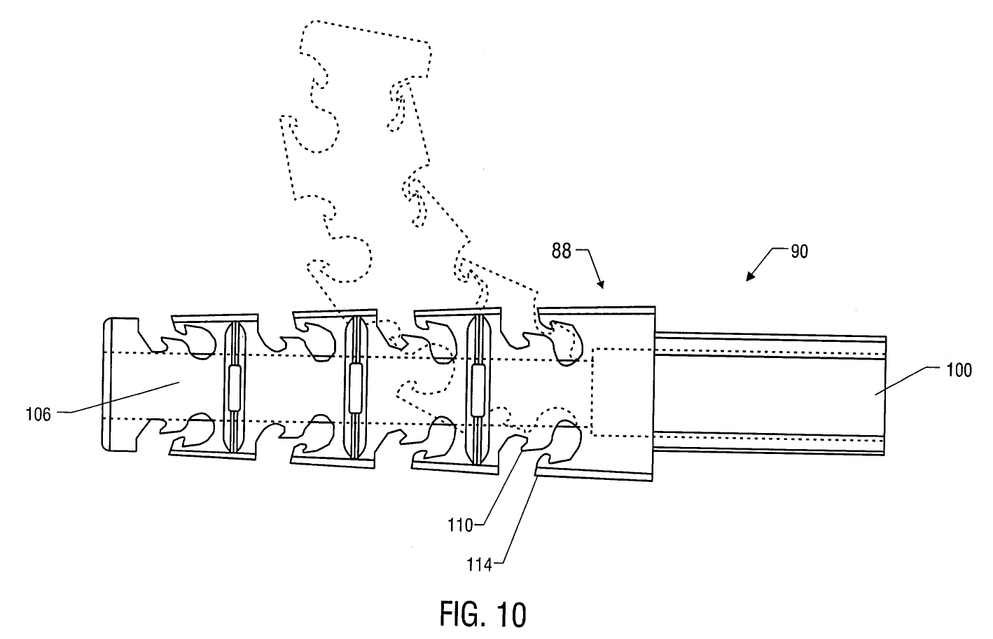

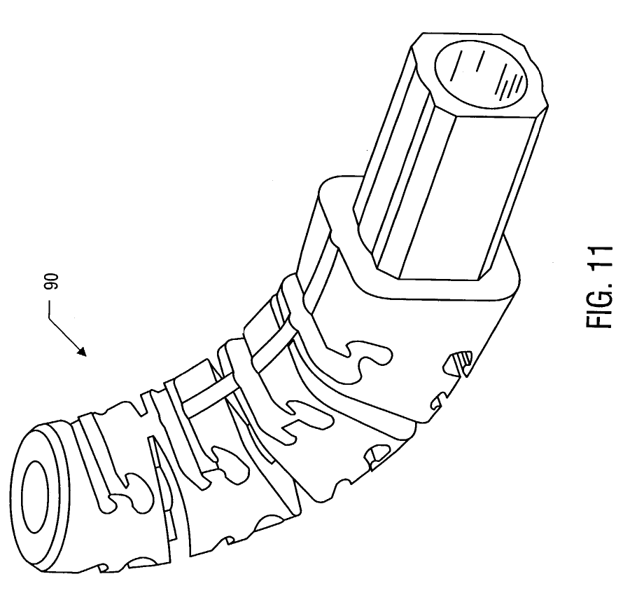

Illustrated in FIG. 10 is the flexible angled boot 90 having outer casing 88 and inner chamber 100, in both the straight (0°) and bent (90°) configurations. As is apparent from the figure, when flexible angled boot 90 is straight, none of the latches 114 are interlocked with hooks 110. FIG. 11 illustrates one embodiment of the flexible angled boot design of the present disclosure, wherein the flexible angled boot 90 is formed of one piece of material. In an alternative embodiment, and still within the scope of the present disclosure, the flexible angled boot 90 can be in two parts that snap or are attached together. Yet another alternative embodiment is a flexible angled boot 90 having a space defined horizontally along one side, wherein the space has a height such that a ribbon cable 31 can readily slide into the angled boot and be held in place by appropriately placed nibs.

A further embodiment of the present disclosure is a flexible angle configurable boot assembly, or alternatively an angled boot assembly, that acts as a fanout/breakout assembly for providing connection of two or more optical ribbon hydras to a variety of equipment or panels that are terminated with MPO, MT or other suitable connectors. The flexible angle configurable boot assembly can act as both the transition piece for the fanout configuration at one end and the connector assembly for coupling the flexible angle boot to the connector. Such a flexible angle configurable boot is capable of use for parallel optical data transmission systems, for example. It is envisioned that such a flexible fanout assembly would be suitable for use with multirow, multifiber connectors such as the XTM-72 72-channel optical transceiver MT-style ferrule produced by Xanoptix, Inc. (Merrimack, N.H.) which are both full-duplex modules and half-duplex modules and use only one single MT-style connector.

The flexible fanout assembly described above can be used in a variety of applications, such as for example with Storage Area Networks (SAN), Synchronous Optical NETwork (SONET) and Very Short Reach (VSR) applications, parallel optical interconnections, optical switch interconnections, parallel optic transceivers, and in standard MPO and MPX connector housings.

In summary, while the apparatus and processes of this disclosure have been described in terms of preferred illustrative embodiments, it will be apparent to those of skill in the art that variations may be applied without departing from the content and scope of the disclosure. Additionally, the apparatus and processes described in this disclosure are not intended to be limited to any particular art. All such similar substitutes and modifications apparent to those skilled in any relevant art where these apparatus and processes may find use are deemed to be within the scope and concept of the disclosure.

What is claimed is:

1. A flexible angle configurable boot for use with a multi-conductor cable.

2. The flexible angle configurable boot of claim 1, further defining a flexibly controlled degree of bend for minimizing bending stress on the cable capable of being locked at an angle.

3. The flexible angle configurable boot of claim 2, wherein the controlled degree of bend defined by the flexible angle configurable boot maintains and controls the bend radius of the cable.

4. The flexible angle configurable boot of claim 1, further defining an area for receiving the multi-conductor cable and positioning the cable at a known orientation with respect to the boot.

5. The flexible angle configurable boot of claim 1 wherein the boot defines a proximal outer housing element that is capable of joining with a coupling assembly.

6. The flexible angle configurable boot of claim 1 wherein the boot comprises a substantially rectangular slot into which the cable is received.

7. The flexible angle configurable boot of claim 1 wherein the controlled degree of bend defined by the flexible angle configurable boot maintains and controls the bend radius of the cable.

8. The flexible angle configurable boot of claim 1 further comprising a coupling assembly.

9. The flexible angle configurable boot of claim 8 wherein the coupling assembly comprises clips.

10. The flexible angle configurable boot of claim 9 wherein the clips comprise an upper element and a lower element.

11. The flexible angle configurable boot of claim 9 wherein the clips consist of thin extending structures, outer housing segments, and an interior recess.

12. The flexible angle configurable boot of claim 1 wherein the flexible angle configurable boot is comprised of an upper element and a lower element capable of being coupled together.

13. A flexible angle configurable boot for use with a multi-conductor cable, wherein the angle configurable boot comprises a proximal end, a distal end, and a plurality of locking elements spaced in between the proximal and distal ends which allow the angle configurable boot to be bent to a specific angle and locked at the angle.

14. The flexible angle configurable boot of claim 13 wherein the angle to which the angle configurable boot can be bent is an angle between about 0° and about 180°.

15. The flexible angle configurable boot of claim 14 wherein the angle to which the angle configurable boot can be bent is an angle between about 0° and about 90°.

16. The flexible angle configurable boot of claim 13 wherein the plurality of locking elements comprise pivot points, latches, hooks, and spaces.

17. The locking elements of claim 16 wherein the spaces are angle-defining spaces.

18. A cable connection assembly for use with a multi-core cable comprising:
(a) a flexible angle configurable boot;
(b) a connector; and
(c) a clip defining a coupling assembly and having an upper and lower portion defining an extending structure, an outer housing segment, and an interior recess.

19. The cable connection assembly of claim 18, wherein the flexible angle configurable boot further comprises a plurality of locking body elements capable of varying the degree of bend for minimizing bending stress on the cable, and at least one capture element at the distal end of the flexible angle configurable boot to receive the cable and minimize unprotected twisting of the cable.

20. A flexible angle configurable boot assembly for use with a multi-conductor cable that includes a connector comprising:
(a) a flexible angle configurable boot that defines an area for receiving the multi-conductor cable and means for positioning the cable at a plurality of angles with respect to cable; and
(b) means for coupling the flexible angle configurable boot to the connector in one of a plurality of alternating orientations.

21. A process for installing a flexible angle configurable boot assembly on a connection cable that includes a multi-conductor cable and a connector comprising:
(a) coupling a clip defining an outer mounting structure to the connection cable at a location where the multi-conductor cable is received by the connector;
(b) positioning the multi-connector cable within the flexible angle configurable boot so as to define the orientation of the multi-element cable with respect to the angled boot;
(c) coupling the flexible angle configurable boot to the outer mounting structure at a desired orientation; and
(d) bending the flexible angle configurable boot to the desired angle and locking it at the angle such that bending stress on the cable is minimized.
